(19) United States
(12) Patent Application Publication
(10) Pub. No.: US 2017/0203460 A1
(43) Pub. Date: Jul. 20, 2017

(54) Data Carrier Production Method and Processing Device

(71) Applicant: GIESECKE & DEVRIENT GMBH, München (DE)

(72) Inventors: Thomas TARANTINO, Laufen (DE); Eric VIROSTEK, Silver Lake, OH (US)

(21) Appl. No.: 15/312,726

(22) PCT Filed: May 12, 2015
(86) PCT No.: PCT/EP2015/000995

§ 371 Date: Nov. 21, 2016

(30) Foreign Application Priority Data
May 27, 2014 (DE) 10 2014 007 930.9

(51) Int. Cl. B26D 7/34; B26F 1/40; B26F 1/44; G06K 19/077

(52) U.S. Cl. CPC B26D 7/34; G06K 19/07722; B26F 1/40; B26F 1/44

(57) ABSTRACT

A data-carrier manufacturing method, and to a processing apparatus for punching data carriers out of a data-carrier sheet involves an application of color effected by means of a color applying device to a circumferential edge of the data carrier in a female punching unit of a punching device.

### TECHNICAL FIELD

The present invention relates to a method for manufacturing a data carrier, and to a processing apparatus with which a data carrier can be manufactured.

A “data carrier” as intended by the invention is understood to be, inter alia, a bank card, in particular a credit card, an identification card, an advantage card and/or an admission ticket, with all these cards having in common that they are capable of storing data. Basic information on the nature, construction and possible applications of data carriers is found in the book “Handbuch der Chipkarten” (“Smart Card Handbook”) (Rankl/Effing, 5th edition).

### PRIOR ART

In the prior art there are known a multiplicity of manufacturing methods for portable data carriers. Said methods relate to different embodiments and possible designs for data carriers, in particular chip cards.

WO 2013/041808 A1 relates to a method for coloring an edge of a stack comprising a multiplicity of data carriers. In said method, a color layer is applied to a data carrier's circumferential card by means of a powder coating device and thereupon dried by means of a heating device.

U.S. Pat. No. 5,888,624 discloses a device by means of which a colored lacquer can be applied to a data carrier's circumferential card. The data carriers can be lacquered individually or in stacked form. Thereupon the data carriers are likewise dried.

Said methods are disadvantageous in that they are relatively elaborate to integrate into a card manufacturing process. For it is always necessary that a punched-out and/or injection-molded data carrier is removed from the fabrication process individually or in stacked form after manufacture and is furnished with a color layer in a further fabrication station.

Further, it is known, as an alternative to merely coloring a data carrier's edge or rim, to laminate the data carrier from a multiplicity of foils, with the individual foils of the foil stack being configured in the desired edge color. This method has the disadvantage of increasing the storage costs in a card manufacturing facility, since a multiplicity of foils in different colors must be held in stock. Further, colored foils are not advantageous upon subsequent printing because they must first be decolorized before printing in order to achieve an optimal printing result. Further, occasional cases are known in which the coloring materials employed in the colored foils have an adverse effect on the data transfer rates of contactless data carriers.

### STATEMENT OF THE INVENTION

The invention is based on the object of providing a data-carrier manufacturing method and processing apparatus that solves the known problems from the prior art and is suitable for providing a simple possibility for applying color to a circumferential edge of a data carrier.

This object is achieved by a data-carrier manufacturing method according to independent claim 1 and by a processing apparatus according to independent claim 7. Preferred embodiments of the data-carrier manufacturing method according to the invention and of the processing apparatus according to the invention result from the subclaims.

The invention is based on the idea of simplifying the application of color to the circumferential edge of a data carrier such that the application of color can be effected in one step with the punching of the data carrier out of the data-carrier sheet.

Accordingly, a data-carrier manufacturing method according to the invention comprises forming a data-carrier sheet, with the dimensions of the data-carrier sheet being greater in at least one dimension than a data carrier to be manufactured, punching the data carrier out of the data-carrier sheet by means of a punching device having a male punching unit (swage) and a female punching unit (die), with the female punching unit bearing a color applying device which interacts with the male punching unit such that an application of color to a data-carrier edge of the punched data carrier is effected upon punching out the data carrier and/or upon discharging the data carrier from the female punching unit.

A punching device is understood to be any kind of device that is suitable for punching a data carrier out of a data-carrier sheet. The punching-out operation is described in the book “Vom Plastik zur Chipkarte” (“From Plastic to a Chip Card”) (Carl Hanser Verlag; Yahya Haghiri, Thomas Tarantino, 1999, chapter 3.1.1). Further shearing and punching methods according to DIN 8588 are described in the book “Dubbel—Taschenbuch für den Maschinenbauer” (“Dubbel—Mechanical Engineering Pocketbook”) (21st edition, Springer-Verlag) in chapter S.4.5.

Instead of the term “punching”, terms like cutting, shear cutting, knife-edge cutting, pinch cutting, splitting, tearing and/or breaking can also be alternatively employed. However, the terms “shear cutting” and “punching” suitably render the operation according to the invention by which at least one individual data carrier is detached from a data-carrier sheet.

With the method according to the invention it is especially advantageously possible to furnish the circumferential data-carrier edge of the freshly punched data carrier with color directly upon the working step of punching out the data carrier and/or upon discharging the data carrier from the female punching unit. This advantageously makes it unnecessary to transfer the data carrier to a separate work station in which an application of color is effected. With the method according to the invention the necessary step of discharging the punched data carrier from the female punching unit can be advantageously utilized for furnishing the circumferential edge with color. This makes it possible to do without employing previously colored foils upon forming the data-carrier sheet when said foils mainly serve the purpose of the data carrier's circumferential edge being colored. Therefore, the elaborate step of decolorizing the data carrier's upper side before printing is no longer required. Further, particularly upon processing a data carrier with a contactless interface, the data-transfer properties of the data carrier are retained, since the data transfer rate of the contactless interface can be reduced upon coloring the foils. Further, coloring the data-carrier edge makes it possible to do without holding in stock a multiplicity of differently colored data-carrier foils, thereby reducing storage costs.

According to one embodiment, applying the color is effected by means of one or more nozzles, impregnated brushes, jet nozzles and/or sponges. In this manner it is possible to ensure a clean and uniform application of color to the data-carrier edge. Further, the employment of said devices enables a fast color change, so that it is especially advantageously possible to produce data carriers in the “lot size of one” without having to plan for long change-over times.

By means of the color applying device it is further possible that the application of color is effected along the circumferential direction of the data-carrier card in sections, wherein a different application of color can be effected in every section. In this manner it is advantageously possible to also apply different color patterns on the circumferential data-carrier edge. For example, there might be applied the colors of the data-carrier issuing company (Corporate Identity) and/or the national colors of the country from which the data carrier stems.

According to a further preferred embodiment, the color applying device is provided in the female punching unit. The color applying device can be provided immediately downstream of a cutting edge of the female punching unit, so that the application of color can be effected directly after cutting. Alternatively, the color applying device can be provided in the discharge region of the data carriers from the female punching unit. The color applying device is to be arranged in the female punching unit such that a neat and uniform application of color can be guaranteed.

The data-carrier sheet out of which the data carriers are punched can be so dimensioned that a multiplicity of data carriers can be punched out thereof.

The advantages of the invention are apparent not only in a method according to the invention, but also in a processing apparatus according to the invention comprising a male punching unit and a female punching unit, with the male and female punching units being configured for punching a data carrier out of a data-carrier sheet, with the female punching unit bearing a color applying device for applying color to an edge, in particular to a circumferential edge, of a data carrier.

With the processing apparatus according to the invention it is especially advantageously possible to apply color to a circumferential edge of a data carrier. The processing apparatus according to the invention makes it possible in a simple manner to utilize the already necessary discharging of the data carriers from the female punching unit for furnishing the data carrier's circumferential edge with color during said discharging.

According to a preferred embodiment, the color applying device is arranged in the female punching unit such that the punched-out data carrier is furnished with color by means of the color applying device upon discharging the data carrier from the processing apparatus, in particular upon discharging the data carrier from the female punching unit. In this manner a seamless integration of the color applying step into the punching operation is possible. Transferring the punched data carrier to an additional color applying station is therefore unnecessary, thereby considerably shortening the manufacture time of the data carriers and ensuring a reliable application of color.

The color applying device can be configured such that a change of the color to be applied is possible without stopping the punching device, in particular between the punching out of two data carriers.

Additionally, there can be provided downstream of the female punching unit a cleaning device which, after the applying of the color to the circumferential edge, frees the two large surfaces of the data carrier from the color that might be applied to the large areas.

### BRIEF DESCRIPTION OF THE DRAWINGS

FIG. 1 shows a processing apparatus according to a first embodiment of the invention;

FIG. 2 shows a processing apparatus according to a second embodiment of the invention;

FIG. 3 shows a data carrier manufactured according to the data-carrier manufacturing method of the invention;

FIG. 4 shows a flowchart representing the sequence of a method according to the invention; and

FIG. 5 shows a prior art processing apparatus.

### DESCRIPTION OF PREFERRED EMBODIMENTS OF THE INVENTION

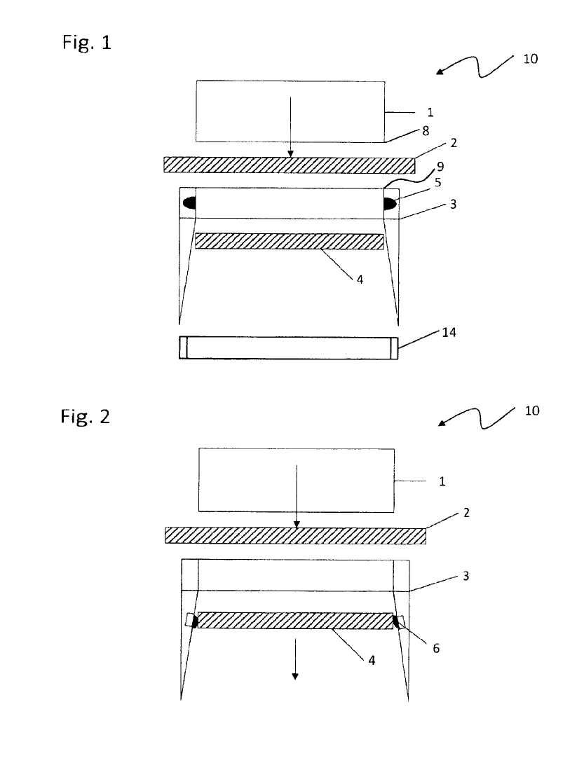

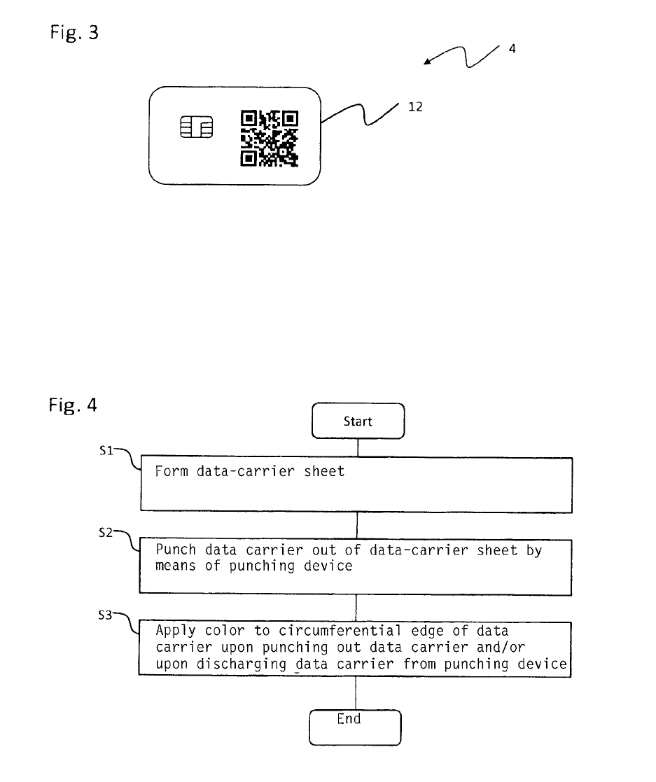

Hereinafter the invention will be described with reference to FIGS. 1 to 4 on the basis of embodiments intended purely by way of example.

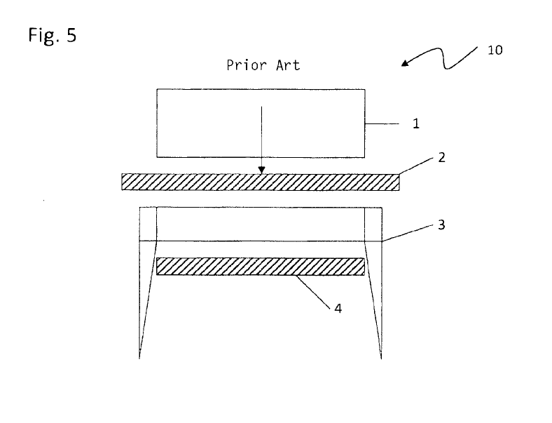

FIG. 5 first shows a processing apparatus 10 according to the prior art. The processing apparatus 10 has a punching device 1, 3 with which a data-carrier sheet 2 can be punched. The processing apparatus 10 has a male punching unit 1 (swage) and a female punching unit 3 (die). The female punching unit 3 has cutting edges 8 which define the outer edges of a data carrier 4. The data-carrier sheet 2 is introduced into the processing apparatus 10. The data-carrier sheet 2 is preferably configured as a previously laminated foil stack. The data-carrier sheet has in at least one dimension a greater dimension than the data carrier 4 to be punched out.

Upon punching the data carrier 4 out of the data-carrier sheet 2 the male punching unit 1 is moved in the direction of the female punching unit 3, the data carrier 4 is punched out and ejected from the female punching unit 3. Alternatively, the male 1 and female 3 punching units can be moved toward each other, or the female punching unit 3 can be moved in the direction of the male punching unit 1.

When an application of color to the edge 12 of the data carrier 4 is to be effected, the data carrier 4 is introduced in the prior art into a downstream station in which an individual data carrier 4 and/or a multiplicity of stacked data carriers 4 are coated with a color.

In the data-carrier manufacturing method according to the invention or the processing apparatus according to the invention, the coating of the data carrier 4 is effected in the female punching unit 3, as shown in FIGS. 1 and 2. For this purpose, an application of color to a circumferential edge 12 of the data carrier 4 is effected by means of a color applying device 5 immediately after punching the data-carrier sheet 2. The color applying device 5 is arranged immediately on a cutting edge 9 of the female punching unit 3. The applied color is in particular a lacquer. The method is advantageous in that the defined feed of the male punching unit 1 can be utilized for guiding the data carrier 4 freshly punched out of the data-carrier sheet 2 past the color applying device 5 at a predetermined feed speed. In this manner a uniform and totally covering application of color to the circumferential edge 12 of the data carrier is effectuated. The method is suited for all flat data carriers having a side edge produced by punching regardless of their construction form. Thus, contactless and/or contact-type data carriers 4 can be manufactured equally well. The data carriers 4 can be employed e.g. as bank cards, credit cards, identification cards, passports, advantage cards and/or admission tickets.

The application of color in the color applying device 5 can be effected by means of one or a multiplicity of nozzles, impregnated brushes, jet nozzles and/or sponges. Downstream of the color applying device 5 there may be a color drying device 14 and/or a UV curing device 14 for curing the color. FIG. 1 shows a combined color drying device and UV curing device 14.

According to one embodiment, the application of color can be effected with the color applying device 6 in the circumferential direction along the data-carrier edge 12 in sections. The individual sections can respectively have a different color.

FIG. 2 shows an alternative embodiment of the processing apparatus 10 according to the invention. In contrast to FIG. 1, the color applying device 6 is arranged in FIG. 2 further away from the cutting edge of the female cutting unit 3. The application of color is effected analogously as with the color applying device 5 in FIG. 1. To guarantee a defined feed of the data carrier through the female punching unit 3, it can be provided that the male punching unit 1 penetrates deeper into the female punching unit 3 in comparison to the embodiment example shown in FIG. 1. Alternatively, additional means, such as a data-carrier discharging apparatus, can be provided in the female punching unit which enable reliable discharging of the punched data carrier 4 from the female punching unit 3 at a defined feed speed.

The color applying device 5, 6 can be so designed that it is capable of applying different colors to the edge 12 of the data carrier 4 in the circumferential direction. In this manner the data carrier can be furnished with different colors in the circumferential direction according to the wishes of the orderer/customer.

The color applying device 5, 6 can further bear a color changing device which enables a quick change of the colors. In this manner it is already possible at the “lot size of one” upon manufacture of data carriers 4 to carry out quick color changes between two consecutive data carriers 4.

Additionally or alternatively to the color changing device, there can be provided a data-carrier cleaning device which is arranged in the processing apparatus 10 and/or behind the processing apparatus 10. The data-carrier cleaning apparatus can be integrated e.g. into the color drying device 14. With the data-carrier cleaning device any excess color occurring on the two large surfaces of the data carrier 4 can be removed.

FIG. 4 shows the sequence of a data-carrier manufacturing method according to the invention. In the first step S1 a data-carrier sheet 2 is formed, e.g. by laminating a plurality of foils. The data-carrier sheet 2 has dimensions that are greater in at least one dimension than the dimensions of the data carrier 4 to be formed. Preferably, a data-carrier sheet 2 has the dimension of a multiplicity of data carriers 4 in the longitudinal direction and transverse direction.

In the subsequent step S2 the data carrier 4 is punched out of the data-carrier sheet 2 by means of a punching device 1, 3 having a male punching unit 1 and a female punching unit 3. While the data carrier 4 is being urged through the female punching unit 3 due to the feed of the male punching unit 1, color is applied to a circumferential edge 12 of the data carrier 4 with a color applying device 5, 6 in a next step S3. The color applying device 5, 6 is part of the female punching unit 3. Due to the punched data carrier 4 being pushed through the female punching unit 3 at a defined feed speed, it is possible to guarantee a uniform application of color with the color applying device 5, 6 to the data carrier 4.

### LIST OF REFERENCE SIGNS

1 Male punching unit

2 Data-carrier sheet

3 Female punching unit

4 Data carrier

5, 6 Color applying device

8 Cutting edge of female punching unit

9 Cutting edge of male punching unit

10 Processing apparatus

12 Data-carrier edge

14 Color drying device, UV curing device

S1-S3 Method steps

1-12. (canceled)

13. A data-carrier manufacturing method, having the following steps:
forming a data-carrier sheet, with the dimensions of the data-carrier sheet being greater in one dimension than a data carrier to be manufactured,
punching the data carrier out of the data-carrier sheet by means of a punching device having a male punching unit and a female punching unit, wherein
the female punching unit bears a color applying device which interacts with the male punching unit such that upon punching out the data carrier and/or upon discharging the data carrier from the female punching unit an application of color to a data-carrier edge of the punched data carrier is effected.

14. The method according to claim 13, wherein the applying of the color is effected by means of one or more nozzles, impregnated brushes, j et nozzles and/or sponges.

15. The method according to claim 13, wherein the application of color is effected along the data-carrier edge in the circumferential direction in sections, wherein a different application of color can be effected in every section.

16. The method according to claim 13, wherein the color applying device is arranged in the female punching unit.

17. The method according to claim 13, wherein forming the data-carrier sheet is effected by laminating a multiplicity of data-carrier foils.

18. The method according to claim 13, wherein the data-carrier sheet is dimensioned such that a multiplicity of data carriers can be punched out thereof.

19. A processing apparatus for punching data carriers out of a data-carrier sheet, having:
a male punching unit and a female punching unit, with the male punching unit and the female punching unit being configured for punching a data carrier out of a data-carrier sheet, wherein
the female punching unit bears a color applying device for applying color to an edge, in a circumferential edge, of a data carrier.

20. The processing apparatus according to claim 19, wherein the color applying device is arranged in the female punching unit such that the punched-out data carrier is furnished with color by means of the color applying device upon discharging the data carrier from the processing apparatus upon discharging from the female punching unit.

21. The processing apparatus according to claim 19, wherein the color is applicable by the color applying device by means of at least one nozzle, impregnated brushes, jet nozzles and/or sponges.

22. The processing apparatus according to claim 19, wherein the color applying device is configured for applying the color along the data-carrier edge in the circumferential direction in sections, wherein a different application of color can be effected in every section.

23. The processing apparatus according to claim 19, wherein the color applying device bears a color changing device.

24. The processing apparatus according to claim 19, wherein the processing apparatus bears a data-carrier cleaning device.
